(19) United States
(12) Patent Application Publication
(10) Pub. No.: US 2015/0175155 A1
(43) Pub. Date: Jun. 25, 2015

(54) VEHICLE AND CONTROL METHOD

(71) Applicants: Naoki Nakanishi, Susono-shi (JP); Shintaro Matsutani, Toyota-shi (JP)

(72) Inventors: Naoki Nakanishi, Susono-shi (JP); Shintaro Matsutani, Toyota-shi (JP)

(73) Assignee: TOYOTA JIDOSHA KABUSHIKI KAISHA, Toyota-shi, Aichi-ken (JP)

(21) Appl. No.: 14/408,116

(22) PCT Filed: Sep. 9, 2013
(86) PCT No.: PCT/IB2013/002036

§ 371 Date: Dec. 15, 2014

(30) Foreign Application Priority Data
Sep. 11, 2012 (JP) 2012-199926

(51) Int. Cl. B60W 20/00; B60W 10/06; B60W 10/02; F01L 13/00; F02D 41/26

(52) U.S. Cl. CPC B60W 20/40; F01L 13/0015; F02D 41/26; B60W 10/02; B60W 10/06; Y10S 903/93

(57) ABSTRACT

When an engine is started while a vehicle is running with power of a motor, an electronic control unit performs engine starting control by partially engaging an engine coupling/decoupling clutch while allowing the clutch to slip so as to raise the engine speed, temporarily reducing engaging force of the engine coupling/decoupling clutch after the engine becomes to rotate by itself, and then fully engaging the engine coupling/decoupling clutch. During the engine starting control, advancement of the valve-closing timing of an intake valve is restricted until the engine coupling/decoupling clutch is fully engaged.

### BACKGROUND OF THE INVENTION

1. Field of the Invention

The invention relates to a vehicle in which engine starting control is performed when an engine is started while the vehicle is running with power of a motor, and also relates to a control method for the vehicle.

2. Description of Related Art

A vehicle including an engine, a motor, and an engine clutch that selectively couples the engine to a power transmission path from the motor to driving wheels is known. A control system for this type of vehicle is disclosed in, for example, Japanese Patent Application Publication No. 2011-016390 (JP 2011-016390 A). The control system for the vehicle disclosed in JP 2011-016390 A performs engine starting control for temporarily releasing the engine clutch during a period from the beginning of engagement of the engine clutch to full engagement thereof, when the engine is started while the vehicle is running only with power of the motor. More specifically, under the engine starting control, the control system initially increases the engine speed by partially engaging the engine clutch while allowing the clutch to slip, and releases the engine clutch when the engine speed reaches a predetermined rotational speed at which it is determined that the engine is able to rotate by itself. Then, the control system for the vehicle further increases the engine speed in a condition where the engine clutch is released. The control system starts an operation to engage the engine clutch after the engine speed becomes higher than the motor speed, and fully engages the engine clutch when the engine speed becomes equal to the motor speed.

The engine starting control performed when the engine is started while the vehicle is running with power of the motor is considerably effective in reducing shocks when the engine is started. When the engine is started under the engine starting control, the engine speed once exceeds the motor speed before the engine clutch reaches a fully engaged state. However, when the motor speed is considerably low, such as when the vehicle is running at a low vehicle speed, the engine speed may largely exceed the motor speed. As a result, a period of time it takes from the time when starting of the engine is initiated to the time when the engine clutch is fully engaged, namely, the period of execution of the engine starting control, is prolonged. Namely, a running-mode transition period required from the time when the engine starting is initiated to the time when a transition to an engine running mode, which is started from the time of full engagement of the engine clutch, is completed, is prolonged. Consequently, it takes a longer period of time from the time when the engine starting is initiated to the time when the output of the engine contributes to vehicle running, resulting in an increase of electric power consumption by the motor; therefore, the fuel efficiency may deteriorate. This problem has not been publicly known.

### SUMMARY OF THE INVENTION

The invention was developed in view of the above situation, and provides a vehicle having an engine and a motor, and a control method therefor, which can suppress deterioration of the fuel efficiency which would occur when the engine is started while the vehicle is running with power of the motor.

A vehicle according to one aspect of the invention includes an engine, a motor, a clutch and a control unit. The engine includes a variable valve timing mechanism for an intake valve, and the variable valve timing mechanism is configured to advance or retard the intake valve timing. The clutch selectively couples the engine to a power transmission path between the motor and driving wheels. The control unit is configured to perform engine starting control when the engine is started in a motor running mode in which the vehicle runs only with power of the motor, by partially engaging the clutch while allowing the clutch to slip so as to raise a rotational speed of the engine, temporarily reducing engaging force of the clutch after the engine becomes to rotate by itself, and then fully engaging the clutch. The control unit is configured to restrict advancement of the valve-closing timing of the intake valve until the clutch is fully engaged, during the engine starting control.

With the above arrangement, advancement of the valve-closing timing is restricted during the engine starting control, so that the intake air amount of the engine is reduced, and engine torque is suppressed. As a result, the engine speed that once exceeds the motor speed is reduced quickly, and becomes equal to the motor speed at an early point in time. Accordingly, the clutch reaches a fully engaged state at an earlier point in time, as compared with the case where advancement of the valve-closing timing is not restricted, and deterioration of the fuel efficiency can be curbed. According to the above aspect of the invention, during the engine starting control, advancement of the valve-closing timing of the intake valve is restricted until the clutch is fully engaged; however, it does not matter whether the restriction is continued after full engagement of the clutch. For example, the restriction may be continued for a while after full engagement of the clutch.

The vehicle as described above may be configured as follows. The control unit is configured to make a throttle opening of the engine smaller than a throttle opening corresponding to a target engine torque, until the clutch is fully engaged, during the engine starting control. With this arrangement, during the engine starting control, the intake air amount of the engine is reduced due to the reduction of the throttle opening, so that engine torque is suppressed. As a result, the engine speed that once exceeds the motor speed is reduced quickly, and becomes equal to the motor speed at an early point in time. Accordingly, the clutch reaches a fully engaged state at an earlier point in time, as compared with the case where the throttle opening is controlled to the opening corresponding to the target engine torque before full engagement of the clutch, and deterioration of the fuel efficiency can be curbed.

The vehicle as described above may be configured as follows. The engine is a direct injection engine. The control unit is configured to restrict advancement of the valve-closing timing of the intake valve, and make the throttle opening smaller than the throttle opening corresponding to the target engine torque, when the engine is started through ignition starting in which fuel is injected into and ignited in a cylinder of the engine from the beginning of rotation of the engine. When the direct injection engine is started through the ignition starting, the engine torque changes steeply in the beginning of engine starting, and the direct injection engine is likely to rev up. This may be said to be the case where the engine speed is likely to exceed the motor speed and increase to a large extent during the engine starting control. In this case, if the vehicle is configured as described above, advancement of the valve-closing timing of the intake valve is restricted, and the throttle opening is made smaller than the opening corresponding to the target engine torque. Namely, control for restricting advancement of the valve-closing timing of the intake valve and control for reducing the throttle opening are performed at more appropriate opportunities, as compared with the case where these controls are performed irrespective of whether the ignition starting is carried out.

Also, the vehicle as described above may be configured as follows. The control unit is configured to restrict advancement of the valve-closing timing of the intake valve, and make the throttle opening smaller than the throttle opening corresponding to the target engine torque, when a rotational speed of the motor is equal to or lower than a predetermined motor speed determination value. When the engine speed temporarily exceeds the motor speed during the engine starting control, an excess of the engine speed over the motor speed increases as the motor speed at that time is lower. This may be said to be the case where the engine speed is likely to exceed the motor speed and increase to a large extent during the engine starting control. In this case, if the vehicle is configured as described above, advancement of the valve-closing timing of the intake valve is restricted, and the throttle opening is made smaller than the opening corresponding to the target engine torque. Namely, control for restricting advancement of the valve-closing timing of the intake valve and control for reducing the throttle opening are performed at more appropriate opportunities, as' compared with the case where these controls are performed irrespective of the level of the motor speed.

Further, the vehicle as described above may be configured as follows. The control unit is configured to make a throttle opening of the engine before full engagement of the clutch smaller than a throttle opening of the engine after full engagement of the clutch, during the engine starting control.

A control method according to another aspect of the invention is applied to a vehicle including an engine, a motor, and a clutch that selectively couples the engine to a power transmission path between the motor and driving wheels. The control method includes executing engine starting control when the engine is started in a motor running mode in which the vehicle runs only with power of the motor, and restricting advancement of a valve-closing timing of an intake valve of the engine until the clutch is fully engaged, during the engine starting control. The engine starting control includes the steps of: raising a rotational speed of the engine by partially engaging the clutch while allowing the clutch to slip, temporarily reducing engaging force of the clutch after the engine becomes to rotate by itself, and then fully engaging the clutch.

### BRIEF DESCRIPTION OF THE DRAWINGS

FIG. 1 is a view schematically showing the construction of a driving system of a hybrid vehicle according to one embodiment of the invention;

FIG. 2 is a cross-sectional view of a combustion chamber and its vicinity of a direct injection engine included in the hybrid vehicle of FIG. 1;

FIG. 3 is a view indicating an intake valve open range in which an intake valve is opened, in relation to the rotational angle of the crankshaft, in the direct injection engine included in the hybrid vehicle of FIG. 1;

FIG. 4 is a functional block, diagram useful for explaining control functions provided in an electronic control unit of FIG. 1;

FIG. 5 is a time chart useful for explaining running-vehicle engine starting control executed by the electronic control unit of FIG. 1 for starting the engine while the vehicle is running with power of a motor; and

FIG. 6 is a flowchart useful for explaining a control routine of the electronic control unit of FIG. 1, namely, a control routine for performing intake valve advancement restriction control and throttle opening restriction control during execution of the running-vehicle engine starting control.

### DETAILED DESCRIPTION OF EMBODIMENTS

One embodiment of the invention will be described in detail with reference to the drawings.

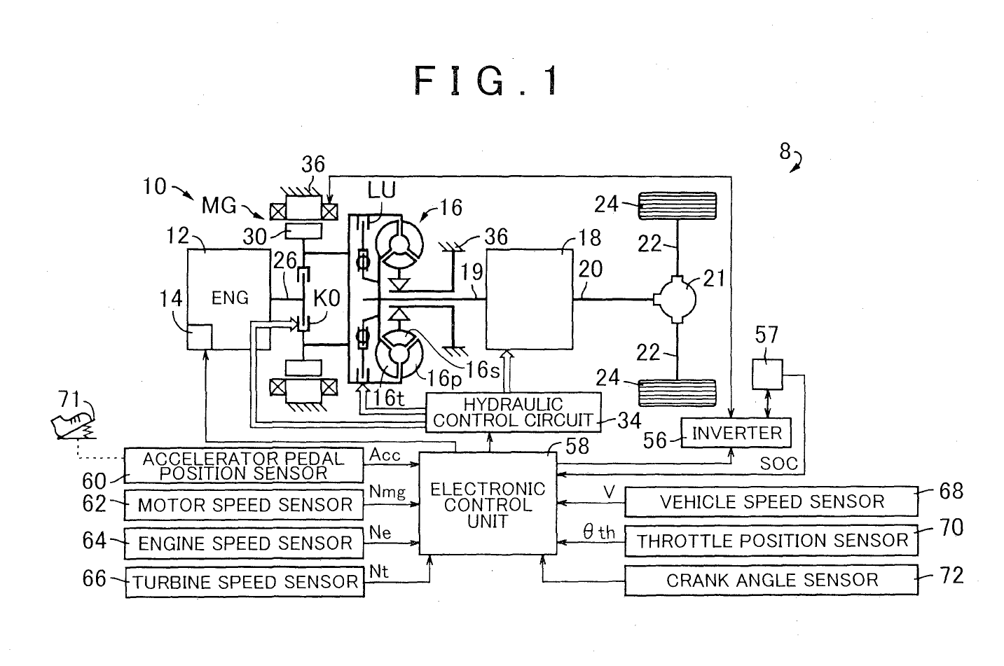

FIG. 1 schematically shows the construction of a driving system of a hybrid vehicle 8 (which will also be simply called “vehicle 8”) as one embodiment of the invention. The hybrid vehicle′ 8 includes a vehicular power train 10 (which will be called “power train 10”), a differential gear device 21, a pair of right and left axles 22, a pair of right and left driving wheels 24, a hydraulic control circuit 34, an inverter 56, and an electronic control unit 58. The power train 10 includes an engine 12 that functions as a, source of driving power for running the vehicle, an engine output control unit 14 that performs engine output control, such as starting or stopping of the engine 12, or throttle control, an electric motor MG for running the vehicle, which functions as a source of driving power for running the vehicle, an engine coupling/decoupling clutch K0 corresponding to the clutch of the invention, a torque converter 16, and an automatic transmission 18. As shown in FIG. 1, the vehicle 8 is constructed such that power generated by one or both of the engine 12 and the motor MG is transmitted to the right and left driving wheels 24, via the torque converter 16, automatic transmission 18, differential gear device 21, and the right and left axles 22, respectively. Thus, the vehicle 8 is able to run in a selected one of an engine running mode in which the vehicle 8 runs with power of the engine 12, and an EV running (motor running) mode in which the vehicle 8 runs only with power of the motor MG while the engine 12 is being stopped. In the engine running mode, the motor MG may generate assist torque, depending on running conditions.

The motor MG, which is connected to the driving wheels 24, is a three-phase synchronous motor, for example. The motor MG is also a motor-generator that functions as a motor that generates power, and also functions as a generator that generates reaction force. For example, the motor MG operates in a regenerative manner so as to generate vehicle braking force. Also, the motor MG is electrically connected to a power storage device 57 via the inverter 56, so that electric power can be supplied and received between the motor MG and the power storage device 57. The power storage device 57 may be, for example, a battery (secondary battery), such as a lead storage battery, or a capacitor.

The engine coupling/decoupling clutch K0 (which will be called “clutch K0”) is provided in a power transmission path between the engine 12 and the motor. MG. The clutch K0 consists of a generally known, wet multiple disc type hydraulic friction device. The clutch K0 operates with a hydraulic pressure supplied from the hydraulic control circuit 34, and functions as a power transmission/cut-off device that selectively couples the engine 12 with the power transmission path from the motor MG to the driving wheels 24. More specifically, when the clutch K0 is engaged, an engine output shaft 26 (e.g., crankshaft) as an output member of the engine 12 is coupled to a rotor 30 of the motor MG such that the engine output shaft 26 and the rotor 30 cannot rotate relative to each other. When the clutch K0 is released, the engine output shaft 26 is disconnected from the rotor 30 of the motor MG. In short, the engine output shaft 26 is selectively coupled to the rotor 30 of the motor MG via the clutch K0. Accordingly, the clutch K0 is completely engaged while the vehicle 8 is running in the engine running mode, and is released while the vehicle 8 is running in the motor running mode. The rotor 30 of the motor MG is coupled to a pump wheel 16p of the torque converter 16 which receives power, such that the rotor 30 and the pump wheel 16p cannot rotate relative to each other.

The automatic transmission 18 constitutes a part of the power transmission path between the torque converter 16 and the driving wheels 24, and transmits power of the engine 12 or motor MG to the driving wheels 24. The automatic transmission 18 is a stepwise variable automatic transmission that performs clutch-to-clutch shifting through engagement and disengagement of coupling elements according to a pre-set relationship (shift diagram), based on the vehicle speed V and the accelerator operation amount Acc, for example. In other words, the automatic transmission 18 is an automatic speed-changing mechanism having a plurality of predetermined gear positions (gear ratios) of which a selected one is established. To establish the selected gear position or gear ratio, the automatic transmission 18 includes a plurality of planetary gear sets, and a plurality of clutches or brakes that operate with hydraulic pressures from the hydraulic control circuit 34. The gear ratio of the automatic transmission 18 is calculated according to an equation that “gear ratio=transmission input rotational speed Natin/transmission output rotational speed Natout”.

The torque converter 16 is a hydraulic power transmission device interposed between the motor MG and the automatic transmission 18. The torque converter 16 includes a pump wheel 16p as an input-side rotational element that receives power of the engine 12 and the motor MG, a turbine wheel 16t as an output-side rotational element that delivers power to the automatic transmission 18, and a stator wheel 16s. In operation, the torque converter 16 transmits power received by the pump wheel 16p to the turbine wheel 16t via a fluid (working oil). The stator wheel 16s is coupled to a transmission case 36 as an irrotational member, via a one-way clutch. The torque converter 16 also includes a lock-up clutch LU located between the pump wheel 16p and the turbine wheel 16t. The lock-up clutch LU selectively establishes direct coupling between the pump wheel 16p and the turbine wheel 16t. The lock-up clutch LU is controlled with a hydraulic pressure supplied from the hydraulic control circuit 34.

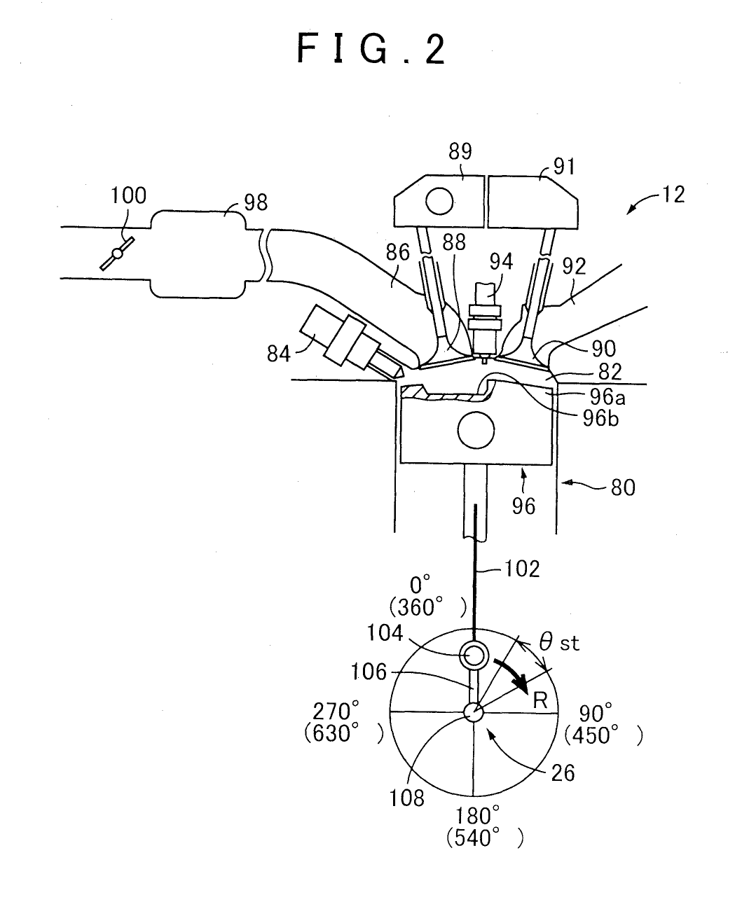

In this embodiment, the engine 12 is a V-eight, four-cycle, direct injection gasoline engine, and has a combustion chamber 82 formed in each cylinder 80. As specifically shown in FIG. 2, gasoline, which is in a condition of fine particles under high pressure, is directly injected from a fuel injection device 84 into the combustion chamber 82. In the engine 12, air flows into the combustion chamber 82, via an intake passage 86 and an intake valve 88, and exhaust gas is discharged from the combustion chamber 82 into an exhaust passage 92 via an exhaust valve 90. In the engine 12, an air-fuel mixture formed in the combustion chamber 82 is ignited at an appropriate time by an ignition device 94, so that the mixture explodes and burns, thereby to push a piston 96 downwards. The engine 12 includes an intake valve driving system 89 that consists of a cam mechanism. The intake valve driving system 89 reciprocates the intake valve 88 in synchronization with rotation of the crankshaft 26, so that the intake valve 88 opens and closes. The engine 12 also includes an exhaust valve driving system 91 that consists of a cam mechanism. The exhaust valve driving system 91 reciprocates the exhaust valve 90 in-synchronization with rotation of the crankshaft 26, so that the exhaust valve 90 opens and closes. The intake passage 86 is connected to an electronic throttle valve 100 via a surge tank 98. The electronic throttle valve 100 is an intake air amount control valve that is operated (i.e., opened and closed) by an electrically-driven actuator. The amount of intake air that flows from the intake passage 86 into the combustion chamber 82, i.e., the engine output, is controlled according to the opening θth (throttle opening θth) of the electronic throttle valve 100. As shown in FIG. 2, the piston 96 includes a piston top portion 96a that is an end portion facing the combustion chamber 82 and forms a part of the combustion chamber 82. The piston top portion 96a includes a recessed portion 96b, or a cavity, which is open toward the combustion chamber 82. The piston 96 is slidably fitted in the cylinder 80, and is coupled to a crank pin 104 of the engine output shaft (crankshaft) 26 via a connecting rod 102, such that the crank pin 104 can rotate relative to the piston 96. Thus, the crankshaft 26 is rotated/driven as indicated by arrow R in FIG. 2 in accordance with linear reciprocating movements of the piston 96. The crankshaft 26 is rotatably supported by a bearing at a journal 108, and includes, as an integral part, a crank arm 106 that connects the journal 108 with the crank pin 104. The shape of the combustion chamber 82, such as the depth of the recessed portion 96b formed in the piston 96, is determined so that the fuel injected from the fuel injection device 84 during normal driving of the engine 12 hits against the recessed portion 96b, and forms a rich air-fuel mixture that contains adequately dispersed fuel and is likely to be ignited, around the ignition device 94, so that favorable explosion can be achieved. During normal driving of the engine 12, the fuel is injected during the compression stroke of each cylinder 80.

The engine 12 goes through four strokes, i.e., the intake stroke, compression stroke, expansion (explosion) stroke, and the exhaust stroke, while the crankshaft 26 makes two revolutions (720°) per cylinder, and these strokes are repeated so that the crankshaft 26 is continuously rotated. The pistons 96 of the eight cylinders 80 are positioned such that the crank angles corresponding to the respective pistons 96 differ by 90° each. In other words, the positions of the crank pins 104 that protrude from the crankshaft 26 are shifted by 90° each. With this arrangement, each time the crankshaft 26 rotates 90°, explosion/combustion takes place in a preset ignition order in the eight cylinders 80, so that rotational torque is continuously generated. Since the engine 12 is a direction injection engine, the engine 12 can be started through ignition starting in which the fuel is injected into the cylinder 80 and ignited from the beginning of rotation of the engine 12. More specifically, the ignition starting, or early ignition, is carried out by an engine starting method as follows. The crankshaft 26 rotates by a given angle from a condition where the piston 96 reaches the compression top dead center (compression TDC) after the compression stroke, and stops. The given angle is within a given angular range θst of the expansion stroke on which the intake valve 88 and the exhaust valve 90 are both closed. At this time, the fuel injection device 84 initially injects gasoline into the cylinder 80 (the combustion chamber 82) that is on the expansion stroke, and the ignition device 94 ignites an air-fuel mixture in the cylinder 80. As a result, the air-fuel mixture in the cylinder 80 explodes and burns so as to raise the engine speed Ne. The engine may be started through the ignition starting, without requiring cranking by the motor MG, etc. However, in this embodiment, the ignition starting is also performed when the engine 12 is started while the vehicle is running in the motor running mode. In this case, in order to enhance the starting performance of the engine 12, the clutch K0 is partially engaged while being allowed to slip, so that motor torque Tmg assists in raising the engine speed Ne. The above-indicated angular range θst, when expressed in terms of the crank angle after the compression top dead center, is preferably the range of about 30° to 60°, for example, in which relatively large rotational energy can be obtained through the ignition starting; however, the ignition starting is possible even when the crank angle after the compression TDC is about 90°.

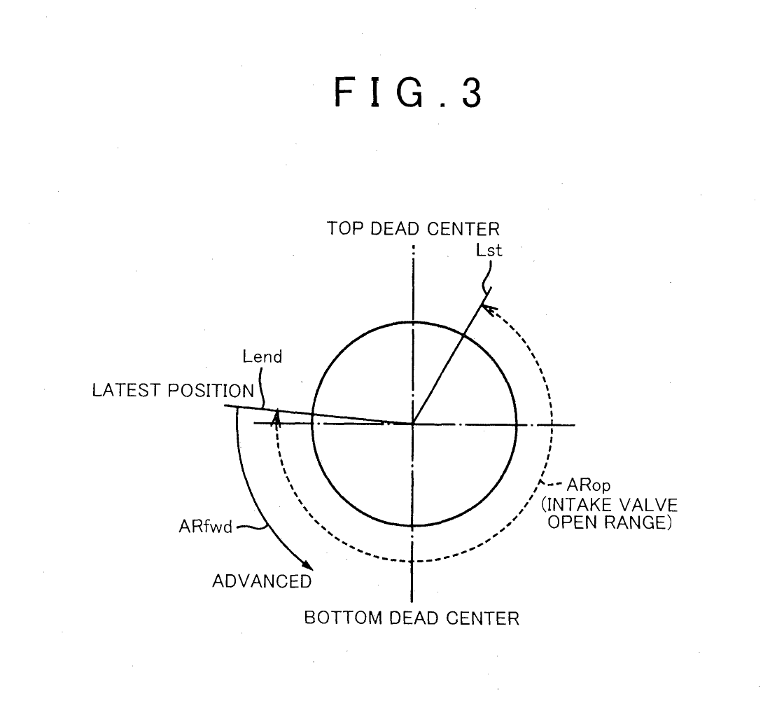

The intake valve driving system 89 also has the function of changing the valve-closing timing of the intake valve 88 as needed, and functions as a variable valve timing mechanism that advances or retards the valve-closing timing of the intake valve 88, for example. For example, the intake valve driving system 89 opens the intake valve 88 over an open range of the intake valve as indicated by broken-line arrow ARop in FIG. 3, during the intake stroke of the engine 12. Namely, in FIG. 3 showing the crank angle, the valve-opening timing of the intake valve 88 is represented by solid line Lst after the top dead center, and the valve-closing timing of the intake valve 88 is represented by solid line Lend after the bottom dead center. The solid line Lend indicates the latest position within the range over which the valve-closing timing of the intake valve 88 can be adjusted, and arrow ARfwd indicates the advancing direction of the valve-closing timing. As is understood from the arrow ARfwd, advancing the valve-closing timing of the intake valve 88 means making the valve-closing timing after the bottom dead center closer to the bottom dead center.

For example, when the engine is started through the above-described ignition starting, the intake valve driving system 89 is controlled so that the opening/closing timing of the intake valve 88, more specifically, at least the valve-closing timing, is shifted (retarded) to the maximum in the retarding direction, within the range in which the valve-closing timing can be adjusted, so as to reduce rotational resistance in the beginning of rotation of the engine 12. Various operating principles of the intake valve driving system 89 are generally known. For example, the intake valve driving system 89 may be a cam mechanism that operates in association with rotation of the crankshaft 26, and operates (i.e., opens and closes) the intake valve 88 by selectively using any of a plurality of cams having mutually different shapes through hydraulic control or electric control. In another example, the intake valve driving system 89 may open and close the intake valve 88, by using a cam mechanism that operates in association with rotation of the crankshaft 26, and a mechanism that modifies the actions of cams of the cam mechanism through hydraulic control or electric control. While the intake valve driving system 89 is only required to change at least the valve-closing timing, the intake valve driving system 89 of this embodiment is arranged to change the valve-opening timing of the intake valve 88 at the same time that it changes the valve-closing timing of the intake valve 88, in the same direction in which the valve-closing timing is changed.

When the hybrid vehicle 8 transits from the motor running mode to the engine running mode, for example, the engine speed Ne is raised by partially engaging the clutch K0 while allowing the clutch K0 to slip, so that the engine 12 is started. More specifically, engine starting control as will be described later is executed for engine starting.

The electronic control unit 58 performs motor regeneration control during deceleration of the vehicle, i.e., when the foot brake or brake pedal is depressed, or during coasting of the vehicle after the driver ceases to perform a braking operation and an accelerating operation. Namely, the electronic control unit 58 supplies regenerative energy obtained by applying a brake to the running vehicle 8 through regenerative operation of the motor MG, to the power storage device 57. More specifically, under the motor regeneration control, the clutch K0 is released so as to cut off power transmission between the engine 12 and the driving wheels 24, and the engine 12 is stopped, so that the motor MG is operated in a regenerative manner with inertial energy possessed by the vehicle 8. Then, the inertial energy is regenerated as electric power, and the power storage device 57 is charged with the electric power from the motor MG. During execution of the motor regeneration control, the lock-up clutch LU is engaged.

The vehicle 8 includes a control system as illustrated in FIG. 1 by way of example. The electronic control unit 58 as shown in FIG. 1 functions as a control unit for controlling the power train 10, and includes a so-called microcomputer. As shown in FIG. 1, the electronic control unit 58 is supplied with various input signals detected by sensors provided in the hybrid vehicle 8. For example, the electronic control unit 58 receives a signal indicative of the accelerator operation amount. Acc as the depression amount of an accelerator pedal 71 detected by an accelerator pedal position sensor 60, a signal indicative of the rotational speed Nmg of the motor MG (motor speed Nmg) detected by a motor speed sensor 62, a signal indicative of the rotational speed Ne of the engine 12 (engine speed Ne) detected by an engine speed sensor 64, a signal indicative of the rotational speed Nt of the turbine wheel 16t of the torque converter 16 (turbine speed Nt) detected by a turbine speed sensor 66, a signal indicative of the vehicle speed V detected by a vehicle speed sensor 68, a signal indicative of the throttle opening θth of the engine 12 detected by a throttle position sensor 70, a signal indicative of the rotational position of the engine output shaft (crankshaft) 26, or crank angle, detected by a crank angle sensor 72, a signal indicative of the state of charge SOC of the power storage device 57 obtained from the power storage device 57, and so forth. Here, the motor speed Nmg detected by the motor speed sensor 62 is equal to the input rotational speed of the torque converter 16, and corresponds to the rotational speed (pump speed) Np of the pump wheel 16p of the torque converter 16. Also, the turbine speed Nt detected by the turbine speed sensor 66 is equal to the output rotational speed of the torque converter 16, and corresponds to the rotational speed Natin of the transmission input shaft 19 of the automatic transmission 18, or the transmission input rotational speed Natin. Also, the rotational speed Natout of the output shaft 20 (which will be called “transmission output shaft 20”) of the automatic transmission 18, or transmission output rotational speed Natout, corresponds to the vehicle speed V. The positive direction of the engine torque Te and motor torque Tmg is the same as the direction of rotation of the engine 12 during driving thereof.

Also, various output signals are supplied from the electronic control unit 58 to respective devices provided in the hybrid vehicle 8.

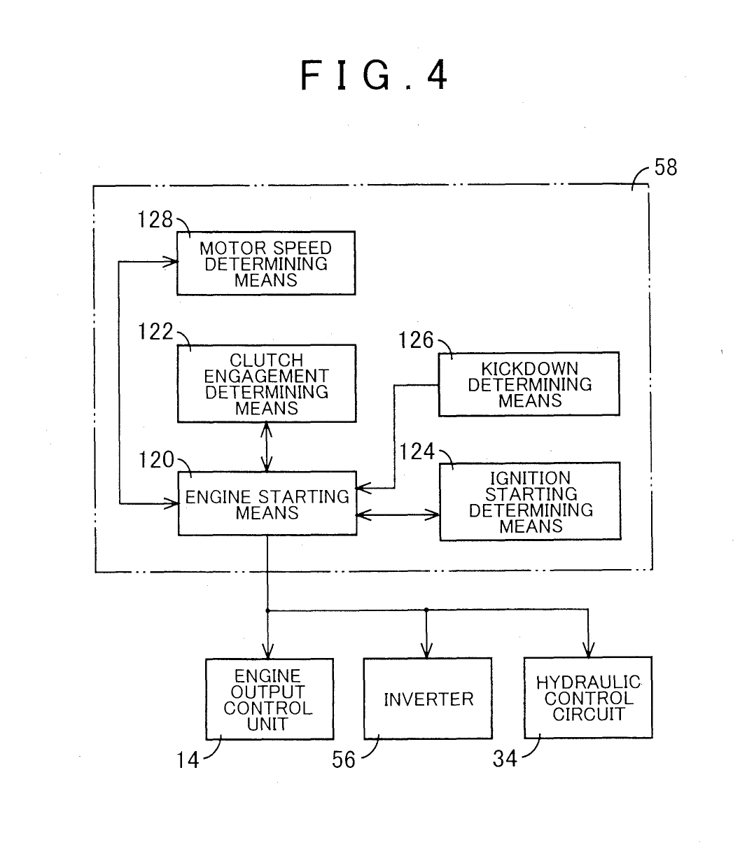

When the engine 12 is started while the vehicle is running in the motor running mode, the electronic control unit 58 of this embodiment performs running-vehicle engine starting control as follows. Initially, the engine speed Ne is raised by partially engaging the clutch K0 while allowing the clutch K0 to slip. After the engine 12 becomes able to rotate by itself, the engaging force of the clutch K0 is temporarily reduced, and then the clutch K0 is fully engaged. While the electronic control unit 58 starts the engine 12 under the above-described running-vehicle engine starting control, it starts the engine 12 through the ignition starting, if possible. When the engine starting under the running-vehicle engine starting control is carried out through the ignition starting, the electronic control unit 58 executes control for suppressing rev-up of the engine 12 (i.e., a rapid increase of the engine speed) immediately after starting of the engine 12 is initiated, and fully engaging the clutch K0 at an early point. A principal part of control functions of the electronic control unit 58 will be described below, with reference to FIG. 4. The running-vehicle engine starting control corresponds to the engine starting control of this invention.

FIG. 4 is a functional block diagram useful for explaining a principal part of control functions included in the electronic control unit 58. As shown in FIG. 4, the electronic control unit 58 functionally includes an engine starting means 120 as an engine starting unit, a clutch engagement determining means 122 as a clutch engagement determining unit, an ignition starting determining means 124 as an ignition starting determining unit, a kickdown determining means 126 as a kickdown determining unit, and a motor speed determining means 128 as a motor speed determining unit.

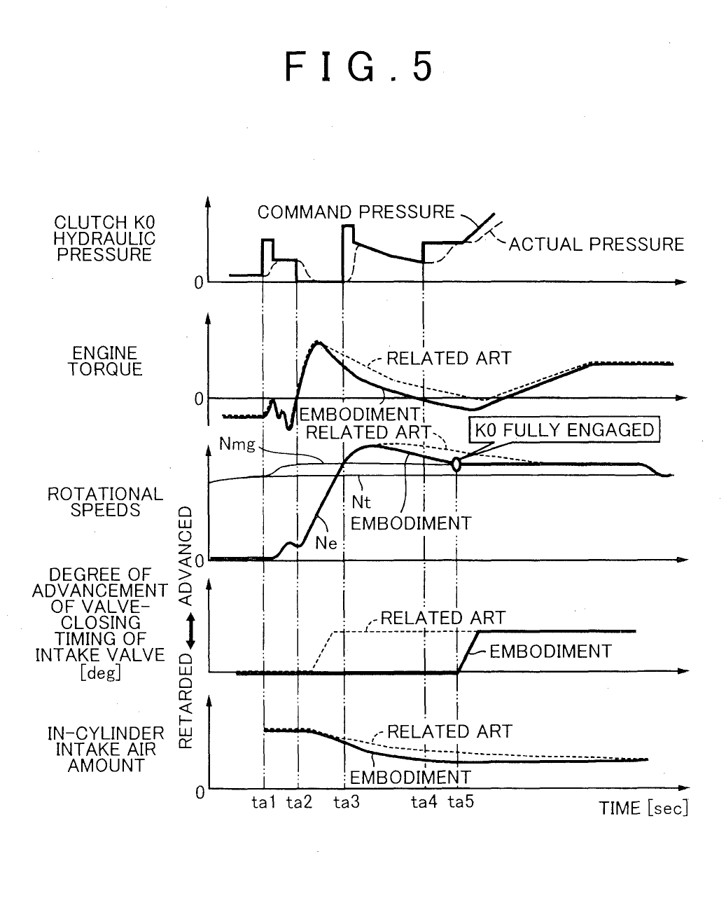

When the engine 12 is started while the vehicle is running in the motor running mode, the engine starting means 120 performs the engine starting control for starting the engine 12 while controlling the engaging force of the clutch K0. At this time, the engine starting means 120 determines whether the ignition starting is feasible, based on the phase of the cylinder 80 that is on the expansion stroke when the engine 12 is in a stopped state. If the ignition starting is feasible, the engine starting means 120 starts the engine 12 through the ignition starting. If, on the other hand, it is determined that the ignition starting is not feasible, normal engine starting is carried out in which the fuel is supplied and ignited after the engine speed Ne is increased to some extent. The engine starting control includes starting of the engine 12 in this manner. For example, when the accelerator operation amount Acc is increased, and the power requirement cannot be satisfied only by the motor MG, an engine start-up request for starting the engine 12 is made so as to switch the vehicle from the motor running mode to the engine running mode. The engine starting means 120 starts the engine 12 by executing the engine starting control, when the engine start-up request is made while the vehicle is running in the motor running mode. FIG. 5 shows a time chart useful for explaining the engine starting control executed by the engine starting means 120.

The time chart of FIG. 5 is used for explaining the running-vehicle engine starting control executed by the electronic control unit 58. Under the running-vehicle engine starting control illustrated in FIG. 5, the engine 12 is started through the ignition starting as described above. In FIG. 5, the engaging hydraulic pressure of the clutch K0, engine torque Te, rotational speeds Ne, Nmg, Nt, the degree of advancement of the closing timing of the intake valve 88, and the amount of intake air in the cylinder, as an accumulated mass of air drawn into each cylinder 80 of the engine 12 per cycle, are indicated in this order as viewed from the top of FIG. 5. In the time chart of the engaging hydraulic pressure, the solid line represents the command value of the engaging hydraulic pressure, or command pressure, and the broken line represents the actual pressure of the engaging hydraulic pressure. In each of the time charts of the engine torque Te, engine speed Ne, degree of advancement, and the in-cylinder intake air amount, the solid line represents this embodiment, and the broken line represents the related art. Namely, the time charts of the related art indicated by the broken lines are obtained in the case where neither intake valve advancement restriction control nor throttle opening restriction control, which will be described later, is executed.

The vehicle 8 runs in the motor running mode since a point prior to time ta1 in FIG. 5, and the engine starting means 120 starts the engine starting control at time ta1. Namely, at time ta1, the engine starting means 120 instructs the hydraulic control circuit 34 to partially engage the clutch K0 while allowing the clutch K0 to slip, and starts the ignition starting of the engine 12. Namely, the engine starting means 120 raises the engine speed Ne by partially engaging the clutch K0 for slip engagement, and start the ignition starting of the engine 12. Therefore, the engine speed Ne starts increasing from zero, at a time slightly later than time ta1. Under the running-vehicle engine starting control, the engine starting means 120 increases or decreases motor torque Tmg, so as to cancel torque, such as rotational resistance of the engine 12, which is transmitted from the clutch K0 to the motor MG. As a result, running torque is less likely or unlikely to be affected by engine starting. Then, at time ta2, the engine starting means 120 determines that the engine 12 has become able to rotate by itself, and instructs the hydraulic control circuit 34 to reduce the engaging force of the clutch K0, based on the determination. More specifically, the engine starting means 120 instructs the hydraulic control circuit 34 to release the clutch K0. Namely, the engine starting means 120 temporarily releases the clutch K0 after the engine 12 becomes able to rotate by itself. The determination that the engine 12 becomes able to rotate by itself may be made, for example, when the engine speed Ne exceeds a predetermined rotational speed, or when the crank angle as measured from the start of rotation of the engine 12 exceeds a predetermined angle. Then, the engine speed Ne, which has increased from a stopped state (i.e., zero), reaches the motor speed Nmg at time ta3. The engine starting means 120 instructs the hydraulic control circuit 34 again to partially engage the clutch K0 while allowing the clutch K0 to slip at time ta3, based, on the determination that the engine speed Ne reaches the motor speed Nmg. Therefore, the engine speed Ne is gradually less likely to increase. The engine speed Ne that exceeds the motor speed Nmg from time ta3 starts decreasing at a time point slightly later than time ta3. Then, at time ta4, the engine starting means 120 instructs the hydraulic control circuit 34 to increase the engaging force of the clutch K0, so as to promote synchronization of rotation of the engine with that of the motor, i.e., to make the engine speed Ne equal to the motor speed Nmg sooner. For example, the engine starting means 120 determines whether a rotational speed difference (=Ne−Nmg) between the engine speed Ne and the motor speed Nmg is equal to or smaller than a predetermined value. The predetermined value is a value that was empirically set in advance so that the engine starting means 120 can determine that the clutch K0 is about to be fully engaged. If the rotational speed difference falls within the predetermined value, the engine starting means 120 instructs the hydraulic control circuit 34 to increase the, engaging force of the clutch K0 as indicated at time ta4. Then, at time ta5, the engine speed Ne becomes equal to the motor speed Nmg. Namely, the engine starting means 120 temporarily releases the clutch K0 between time ta2 and time ta3, and then fully engages the clutch K0 at time ta5. Then, the running-vehicle engine starting control ends at time ta5.

Referring back to FIG. 4, once the running-vehicle engine starting control is initiated, the clutch engagement determining means 122 sequentially determines whether the clutch K0 is fully engaged. For example, the clutch engagement determining means 122 sequentially detects the engine speed Ne and the motor speed Nmg, and sequentially calculates a clutch rotational speed difference DNK0 as a rotational speed difference (=Ne−Nmg) between the engine speed Ne and the motor speed Nmg. When the clutch K0 is operated to be engaged, and the clutch rotational speed difference DNK0 becomes equal to zero, the clutch engagement determining means 122 determines that the clutch K0 is fully engaged. On the other hand, if the clutch rotational speed difference DNK0 is not equal to zero, the clutch engagement determining means 122 determines that the clutch K0 is not fully engaged. More specifically described referring to the time chart of FIG. 5, the clutch engagement determining means 122 determines until time ta5 that the clutch K0 is not fully engaged, and determines at time ta5 that the clutch K0 is fully engaged. For example, a range of the clutch rotational speed difference DNK0 in which the engine speed Ne is regarded as being substantially equal to the motor speed Nmg (i.e., the engine 12 and the motor MG appear to rotate in synchronization) is empirically set in advance as a synchronization determination range DNK01. The clutch engagement determining means 122 may determine that the clutch K0 is fully engaged, when the clutch rotational speed difference DNK0 sequentially calculated falls within the synchronization determination range DNK01.

When the running-vehicle engine starting control is initiated, the ignition starting determining means 124 determines whether engine starting under the running-vehicle engine starting control is carried out through the ignition starting. In short, the ignition starting determining means 124 determines whether the engine starting means 120 carries out the ignition starting of the engine 12.

The kickdown determining means 126 sequentially determines whether a kickdown determination that kickdown takes place in the automatic transmission 18 has been made. When kickdown takes place in the automatic transmission 18, it is more necessary to increase engine torque Te quickly and rev up the engine 12, rather than suppressing starting shocks of the engine 12. Therefore, the kickdown determining means 126 determines whether the kickdown determination has been made. For example, the electronic control unit 58 makes the kickdown determination, when the accelerator pedal 71 is depressed, and the accelerator pedal operation amount Acc is increased until the accelerator pedal 71 almost reaches the fully depressed position. If a kickdown switch is provided in the vehicle 8, the electronic control unit 58 makes the kickdown determination when the kickdown switch is turned ON.

The motor speed determining means 128 determines whether the motor speed Nmg is equal to or lower than a predetermined motor speed determination value N1mg, when the running-vehicle engine starting control is initiated. The motor speed Nmg to be compared with the motor speed determination value N1mg may be detected at any point in time during a period from the beginning of the running-vehicle engine starting control to the end thereof. For example, it is the motor speed Nmg detected when the running-vehicle engine starting control is initiated. The motor speed determination value N1mg is empirically set in advance, so that, if the motor speed Nmg is equal to or lower than the motor speed determination value N1mg, it can be determined that engine torque Te needs to be suppressed. The engine torque Te is suppressed so that the engine speed Ne that once exceeds the motor speed Nmg under the running-vehicle engine starting control is made equal to the motor speed Nmg at an early point in time.

The engine starting means 120 executes the running-vehicle engine starting control as described above referring to FIG. 5. Furthermore, during the running-vehicle engine starting control, advancing the valve-closing timing of the intake valve 88 (which may be abbreviated to and expressed as “intake valve closing timing”) is restricted until the clutch K0 is fully engaged. Namely, intake valve advancement restriction control that places such a restriction is performed. The determination as to whether the clutch K0 is fully engaged is made by the clutch engagement determining means 122. More specifically, the engine starting means 120 does not always perform the intake valve advancement restriction control during execution of the running-vehicle engine starting control, but performs the intake valve advancement restriction control when the engine starting under the running-vehicle engine starting control is caused by the ignition starting, and the kickdown determination is not made, while the motor speed Nmg is equal to or lower than the motor speed determination value N1mg. The ignition starting determining means 124 determines that the engine starting is caused by the ignition starting. The kickdown determining means 126 determines that the kickdown determination is not made. The motor speed determining means 128 determines that the motor speed Nmg is equal to or lower than the motor speed determination value N1mg.

The engine starting means 120 performs the intake valve advancement restriction control by controlling the intake valve driving system 89. More specifically described referring to the time chart of FIG. 5, under the intake valve advancement restriction control, the engine starting means 120 delays the time at which the intake valve closing timing is advanced from the timing at the beginning (time ta1) of starting of the engine 12, until the time (time ta5) when the clutch K0 is fully engaged. More specifically, in FIG. 5, the intake valve closing timing is set to the most retarded or latest position (see solid line Lend in FIG. 3) at time ta1 when, starting of the engine 12 is initiated, and the intake valve closing timing is kept being at the latest position without being advanced, until time ta5 when the clutch K0 is fully engaged. Then, the engine starting means 120 finishes the intake valve advancement restriction control since the clutch K0 is fully engaged at time ta5, and controls the intake valve driving system 89 from time ta5 so as to advance the intake valve closing timing to be close to the bottom dead center (see FIG. 3). For example, the intake valve closing timing is advanced from time ta5, so that engine torque Te commensurate with the accelerator pedal operation amount Acc is produced. As is understood from a comparison between the broken line and the solid line in the time chart indicating the degree of advancement of the valve-closing timing of the intake valve 88 in FIG. 5, the intake valve closing timing is advanced immediately after the engine 12 becomes able to rotate by itself according to the related art (broken line), whereas the start of advancement of the intake valve closing timing is delayed until time ta5 in this embodiment (solid line).

Also, during the running-vehicle engine starting control, the engine starting means 120 performs throttle opening restriction control for making the throttle opening θth smaller than the opening corresponding to a target engine torque Tet, until the clutch K0 is fully engaged. More specifically, like the intake valve advancement restriction control, the engine starting means 120 does not always perform the throttle opening restriction control during execution of the running-vehicle engine starting control, but performs the throttle opening restriction control when the engine starting under the running-vehicle engine starting control is caused by the ignition starting, and the kickdown determination is not made, while the motor speed Nmg is equal to or lower than the motor speed determination value N1mg. The ignition starting determining means 124 determines that the engine starting is caused by the ignition starting. The kickdown determining means 126 determines that the kickdown determination is not made. The motor speed determining means 128 determines that the motor speed Nmg is equal to or lower than the motor speed determination value N1mg. In short, the engine starting means 120 performs the throttle opening restriction control as well as the intake valve advancement restriction control, when the above-described conditions are satisfied.

For example, under the throttle opening restriction control, the engine starting means 120 keeps the throttle opening θth at a preset opening, from the time (time ta1 in FIG. 5) when the ignition starting is initiated, to the time (time ta5 in FIG. 5) when the clutch K0 is fully engaged. The preset opening, which is empirically set in advance, is the minimum opening that permits the ignition starting. Then, after the clutch K0 is fully engaged, the throttle opening θth is increased to the opening corresponding to the target engine torque Tet. In short, under the throttle opening restriction control, the engine starting means 120 keeps the throttle opening θth smaller than the opening to be established after the clutch K0 is fully engaged, until the clutch K0 is fully engaged. In this connection, the target engine torque Tet is a target value of engine torque Te, and is sequentially determined based on the accelerator pedal operation amount Acc, the vehicle speed V, the gear ratio of the automatic transmission 18, etc., from relationships empirically determined in advance so that driving force or power requested by the driver can be obtained.

Thus, the intake valve advancement restriction control and the throttle opening restriction control are performed during execution of the running-vehicle engine starting control, so that the in-cylinder intake air amount detected after the engine 12 becomes able to rotate by itself is reduced as compared with that of the related art, as shown in the time chart of FIG. 5. As a result, the engine torque Te is reduced as compared with that of the related art. Consequently, as indicated in the time chart of the engine speed Ne, the engine speed Ne that once exceeds the motor speed Nmg during execution of the running-vehicle engine starting control becomes equal to the motor speed Nmg at an earlier point in time as compared with that of the related art, and the clutch K0 is fully engaged at an earlier point in time, as compared with that of the related art.

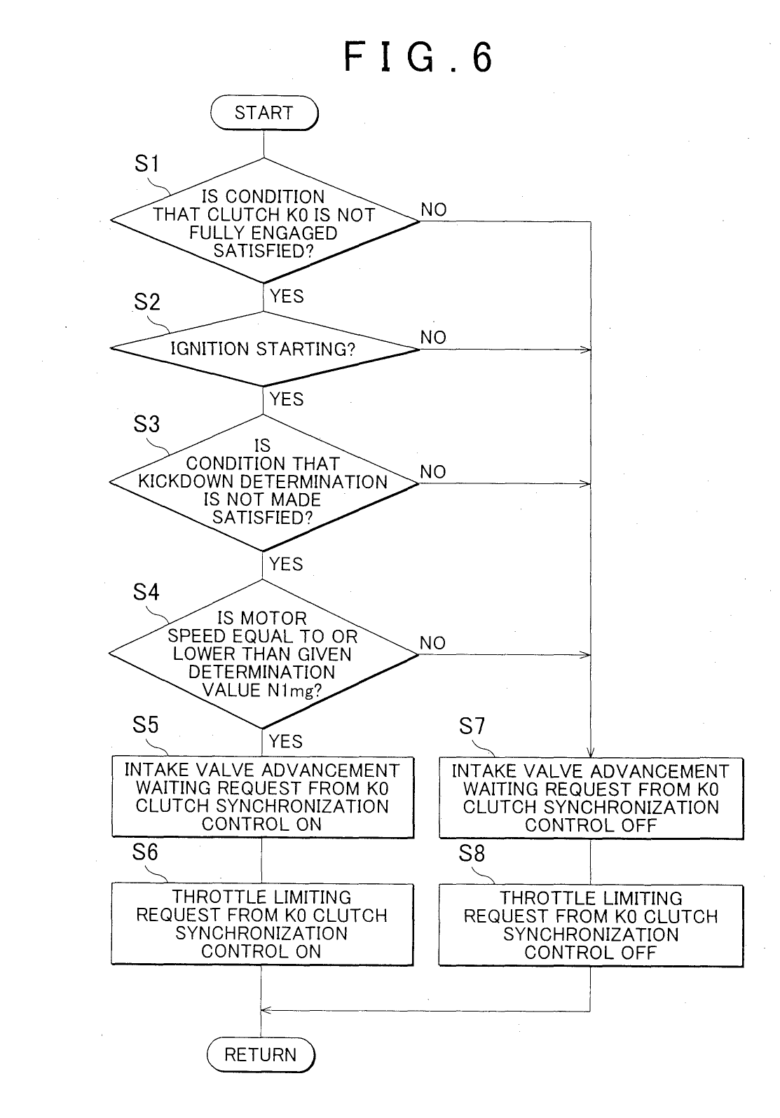

FIG. 6 is a flowchart useful for explaining a principal part of a control routine of the electronic control unit 58, namely, a control routine for performing the intake valve advancement restriction control and the throttle opening restriction control during execution of the running-vehicle engine starting control. For example, the control routine as illustrated in FIG. 6 is started when the running-vehicle engine starting control is initiated, and is repeatedly executed. The control routine as illustrated in FIG. 6 may be executed alone, or may be executed in parallel with other control routines.

Initially, in step S1 of FIG. 6, it is determined whether a condition that the clutch K0 is not fully engaged is satisfied. For example, it is determined that the clutch K0 is not fully engaged if the engine speed Ne is not equal to the motor speed Nmg (i.e., if rotation of the engine is not in synchronization with that of the motor). On the other hand, if the clutch K0 is operated so as to be engaged, and the engine speed Ne is equal to the motor speed Nmg, it is determined that the clutch K0 is fully engaged. If an affirmative decision (YES) is made in step S1, namely, if the clutch K0 is not fully engaged, the control proceeds to step S2. On the other hand, if a negative decision (NO) is made in step S1, namely, if the clutch K0 is fully engaged, the control proceeds to step S7. It is to be noted that step S1 corresponds to the clutch engagement determining means 122.

In step S2, it is determined whether the ignition starting is carried out in the engine starting. This determination is made by the ignition starting determining means 124. If an affirmative decision (YES) is made in step S2, namely, if the ignition starting is carried out, the control proceeds to step S3. On the other hand, if a negative decision (NO) is, made in step S2, the control proceeds to step S7.

In step S3, it is determined whether a condition that the kickdown determination is not made (i.e., no kickdown takes place in the automatic transmission 18) is satisfied. This determination is made by the kickdown determining means 126. If an affirmative decision (YES) is made in step S3, namely, if the kickdown determination is not made, the control proceeds to step S4. On the other hand, if a negative decision (NO) is made in step S3, namely, if the kickdown determination is made, the control proceeds to step S7.

In step S4, it is determined whether the motor speed Nmg is equal to or lower than the predetermined motor speed determination value N1mg. This determination is made by the motor speed determining means 128. If an affirmative decision (YES) is made in step S4, namely, if the motor speed Nmg is equal to or lower than the motor speed determination value N1mg, the control proceeds to step S5. On the other hand, if a negative decision (NO) is made in step S4, the control proceeds to step S7.

In step S5, an intake valve advancement waiting request as a request for waiting for advancement of the valve-closing timing of the intake valve 88 from the beginning of the running-vehicle engine starting control is made. Namely, the intake valve advancement restriction control is executed, and, if the intake valve advancement restriction control has already started being executed, the control continues to be executed. Step S5 is followed by step S6. The running-vehicle engine starting control, which is performed so as to start the engine 12 and finally fully engage the clutch K0, may also be called “K0 clutch synchronization control”.

In step S6, a throttle limiting request as a request for limiting the throttle opening θth from the beginning of the running-vehicle engine starting control is made. Namely, the throttle opening restriction control is executed, and, if the throttle opening restriction control has already started being executed, the control continues to be executed.

In step S7, if the intake valve advancement waiting request has been made, the intake valve advancement waiting request is cancelled. If the intake valve advancement waiting request is not made, the control proceeds to the next step while the intake valve advancement waiting request is not made. Namely, if the intake valve advancement restriction control is being executed, the intake valve advancement restriction control is terminated. If the intake valve advancement restriction control is not being executed, the control proceeds to the next step while the same control is not being executed.

In step S8, if the throttle limiting request has been made, the throttle limiting request is cancelled. If the throttle limiting request is not made, the control proceeds to the next step while the throttle limiting request is not made. Namely, if the throttle opening restriction control is being executed, the throttle opening restriction control is terminated. If the throttle opening restriction control is not being executed, the control proceeds to the next step while the same control is not being executed. It is to be noted that step S5 through step S8 correspond to the engine starting means 120.

In this embodiment as described above, when the engine 12 is started while the vehicle is running only with power of the motor MG, the electronic control unit 58 performs the running-vehicle engine starting control (the engine starting control of this invention) by partially engaging the clutch K0 while allowing the clutch K0 to slip so as to raise the engine speed Ne, temporarily reducing the engaging force of the clutch K0 after the engine 12 becomes able to rotate by itself, and then fully engaging the clutch K0. During the running-vehicle engine starting control, the intake valve advancement restriction control for restricting advancement of the valve-closing timing of the intake valve 88 until the clutch K0 is fully engaged. With this control, during the running-vehicle engine starting control, the intake air amount of the engine 12, e.g., the in-cylinder intake air amount as indicated in FIG. 5, is reduced due to the restriction on advancement of the intake valve closing timing, so that the engine torque Te is suppressed. As a result, the engine speed Ne that once exceeds the motor speed Nmg is reduced quickly, and becomes equal to the motor speed Nmg at an early point in time (see FIG. 5). Accordingly, the clutch K0 reaches full engagement at an earlier point in time, as compared with the case where the advancement of the intake valve closing timing is not restricted, and deterioration of the fuel efficiency can be curbed. Also, when the vehicle 8 transits from the motor running mode to the engine running mode, a period of time (e.g., a period from time ta1 to time ta5 in FIG. 5) it takes from the beginning of starting of the engine 12 to the full engagement of the clutch K0 is shortened as compared with the case where advancement of the intake valve closing timing is not restricted. Therefore, it is possible to cause the output of the engine 12 to contribute to vehicle running early, and reduce a delay in response of driving force.

According to this embodiment, during the running-vehicle engine starting control, the electronic control unit 58 performs the throttle opening restriction control for making the throttle opening θth smaller than the opening corresponding to the target engine torque Tet until the clutch K0 is fully engaged. With this control, during the running-vehicle engine starting control, the intake air amount of the engine 12, for example, the in-cylinder intake air amount as indicated in FIG. 5, is reduced due to the reduction of the throttle opening θth, so that the engine torque Te is suppressed. As a result, the engine speed Ne that once exceeds the motor speed Nmg is reduced quickly, and becomes equal to the motor speed Nmg at an early point in time (see FIG. 5). Accordingly, as compared with the case where the throttle opening θth is controlled to the opening corresponding to the target engine torque Tet before the clutch K0 is fully engaged, in other words, as compared with the case where the throttle opening restriction control is not executed at all, the clutch K0 reaches full engagement at an earlier point in time, and deterioration of the fuel efficiency can be curbed. Also, when the vehicle 8 transits from the motor running mode to the engine running mode, a period of time (e.g., a period from time ta1 to time ta5 in FIG. 5) it takes from the beginning of starting of the engine 12 to the full engagement of the clutch K0 is shortened as compared with the case where the throttle opening restriction control is not executed at all. Therefore, it is possible to cause the output of the engine 12 to contribute to vehicle running early, and reduce a delay in response of driving force.

According to this embodiment, the intake valve advancement restriction control and the throttle opening restriction control are executed when the engine 12 is started through the ignition starting. When the engine 12 as a direct injection engine is started through the ignition starting, the engine torque Te changes steeply in the beginning of engine starting, and the engine 12 is likely to rev up. Accordingly, the intake valve advancement restriction control and the throttle opening restriction control are performed particularly when the engine speed Ne is likely to exceed the motor speed Nmg and increase to a large extent during the running-vehicle engine starting control. Namely, the electronic control unit 58 is able to perform the intake valve advancement restriction control and the throttle opening restriction control at more appropriate opportunities, as compared with the case where these controls are performed irrespective of whether the ignition starting is carried out.

According to this embodiment, the intake valve advancement restriction control and the throttle opening restriction control are executed when the motor speed Nmg is equal to or lower than the predetermined motor speed determination value N1mg. When the engine speed Ne temporarily exceeds the motor speed Nmg during the running-vehicle engine starting control, an excess of the engine speed Ne over the motor speed Nmg increases as the motor speed Nmg at that time is lower. Accordingly, the intake valve advancement restriction control and the throttle opening restriction control are performed particularly when the engine speed Ne is likely to exceed the motor speed Nmg and increase to a large extent during the running-vehicle engine starting control. Namely, the electronic control unit 58 is able to perform the intake valve advancement restriction control and the throttle opening restriction control at more appropriate opportunities, as compared with the case where these controls are performed irrespective of the level of the motor speed Nmg.

The control unit may restrict advancement of the valve-closing timing of the intake valve until the clutch is fully engaged, which means that the time at which the valve-closing timing may be advanced from the timing at the beginning of starting of the engine, until the time when the clutch is fully engaged.

In the ignition starting, the fuel may initially be injected into and ignited in a cylinder whose piston position is on the expansion stroke, out of a plurality of cylinders included in the direction injection engine.

The vehicle may include a hydraulic power transmission device having an input-side rotational element that receives power from the engine and the motor, and an output-side rotational element that delivers the power to the driving wheels.

While one embodiment of the invention has been described in detail with reference to the drawings, it is to be understood that the above-described embodiment is a mere example of the invention, and the invention may be embodied with various changes, or improvements, based on the knowledge of a person having ordinary skill in the art.

For example, while the automatic transmission 18 is a stepwise variable transmission in the above-described embodiment, it may be a continuously variable transmission (CVT) whose speed ratio can be continuously changed. Also, the automatic transmission 18 may be eliminated.

While the engine 12 is a V-type engine in the above-described embodiment, it may be another type of engine, such as an inline or straight engine, or a horizontally-opposed engine. Also, the engine 12 is not limited to an eight-cylinder engine, but may be an engine having three cylinders, four cylinders, six cylinders, or ten cylinders, for example.

While the fuel used in the engine 12 is gasoline in the above-described embodiment, the fuel may be ethanol, or a blended fuel of ethanol and gasoline, or may be hydrogen, LPG, etc.

In the time chart of FIG. 5 in the above-described embodiment, the engine starting means 120 releases the clutch K0 at time ta2. However, the clutch K0 is not necessarily fully released, but the engaging force of the clutch K0 may be reduced as compared with that before time ta2, so that slight engaging force that is almost equivalent to the released state remains after time ta2.

While the engine 12 and the motor MG are mounted on the same axis, as shown in FIG. 1, in the above-described embodiment, the motor MG may be mounted on a different axis from that of the engine 12, and may be operatively coupled to between the clutch K0 and the torque converter 16, via a speed change gear or a chain, for example.

While the torque converter 16 includes the lock-up clutch LU in the above-described embodiment, it may not include the lock-up clutch LU. A vehicular power train that is not provided with the torque converter 16 itself may also be considered.

While the torque converter 16 is used as the hydraulic power transmission device in the above-described embodiment, the torque converter 16 may be replaced with a fluid coupling having no torque amplifying function, for example.

While the flowchart of FIG. 6 includes step S6 and step S8 in the above-described embodiment, the flowchart may not include step S6 and step S8.

While the flowchart of FIG. 6 includes step S2 to step S4 in the above-described embodiment, the flowchart may not include a part of or all of steps S2 to S4. For example, in a flowchart that does not include all of steps S2 to S4, if an affirmative decision (YES) is made in step S1, the control proceeds to step S5. In a flowchart that does not include step S2, the engine may be started without performing the ignition starting, and the engine 12 may not be a direction injection engine.

In the above-described embodiment, the intake valve advancement restriction control is to restrict advancement of the intake valve closing timing until the clutch K0 is fully engaged. However, the restriction on advancement of the intake valve closing timing is not limited to the case where the time at which advancement of the intake valve closing timing is started is delayed until the time (time ta5) when the clutch K0 is fully engaged, as shown in FIG. 5. For example, under the restriction control, advancement of the intake valve closing timing may be started before the clutch K0 is fully engaged, and the operation to advance the intake valve closing timing may not be completed until the clutch K0 is fully engaged. In another example, under the restriction control, the operation to advance the intake valve closing timing may be performed over a longer period of time, as compared with the case where the intake valve advancement restriction control is not executed. For example, under the restriction control, the intake valve closing timing may be gradually or slowly advanced within a range in which the valve closing timing is still retarded as compared with the case where the intake valve advancement restriction control is not executed. In short, under the restriction control, the intake valve closing timing is only required to be retarded as compared with the case where the intake valve advancement restriction control is not executed, namely, the case where the engine is in normal operation.

1. A vehicle comprising:
an engine including a variable valve timing mechanism for an intake valve, the variable valve timing mechanism being configured to advance or retard a valve-closing timing;
a motor;
a clutch that selectively couples the engine to a power transmission path between the motor and driving wheels; and
an electronic control unit configured to perform engine starting control when the engine is started in a motor running mode in which the vehicle runs only with power of the motor, by partially engaging the clutch while allowing the clutch to slip so as to raise a rotational speed of the engine, temporarily reducing engaging force of the clutch after the engine becomes to rotate by itself, and then fully engaging the clutch,
the electronic control unit being configured to
(i) restrict advancement of the valve-closing timing of the intake valve until the clutch is fully engaged, during the engine starting control, and
(ii) advance the valve-closing timing of the intake valve after the clutch is fully engaged.

2. The vehicle according to claim 1, wherein
the electronic control unit is configured to make a throttle opening of the engine smaller than a throttle opening corresponding to a target engine torque, until the clutch is fully engaged, during the engine starting control.

3. The vehicle according to claim 2, wherein:
the engine is a direct injection engine; and
the electronic control unit is configured to restrict advancement of the valve-closing timing of the intake valve, and make the throttle opening smaller than the throttle opening corresponding to the target engine torque, when the engine is started through ignition starting in which a fuel is injected into and ignited in a cylinder of the engine from a beginning of rotation of the engine.

4. The vehicle according to claim 2, wherein
the electronic control unit is configured to restrict advancement of the valve-closing timing of the intake valve, and make the throttle opening smaller than the throttle opening corresponding to the target engine torque, when a rotational speed of the motor is equal to or lower than a predetermined motor speed determination value.

5. The vehicle according to claim 1, wherein
the electronic control unit is configured to make a throttle opening of the engine before full engagement of the clutch smaller than a throttle opening of the engine after full engagement of the clutch, during the engine starting control.

6. A control method for a vehicle including an engine, a motor, a clutch that selectively couples the engine to a power transmission path between the motor and driving wheels, and an electronic control unit, comprising:
executing, by the electronic control unit, engine starting control, when the engine is started in a motor running mode in which the vehicle runs only with power of the motor, including the steps of i) raising a rotational speed of the engine by partially engaging the clutch while allowing the clutch to slip, ii) temporarily reducing engaging force of the clutch after the engine becomes to rotate by itself, and iii) fully engaging the clutch after the step ii);
restricting, by the electronic control unit, advancement of a valve-closing timing of an intake valve of the engine until the clutch is fully engaged, during the engine starting control; and
advancing, by the electronic control unit, the valve-closing timing of the intake valve after the clutch is fully engaged.

7. The control method according to claim 6, wherein
a throttle opening of the engine is made smaller than a throttle opening corresponding to a target engine torque, until the clutch is, fully engaged, during the engine starting control.

8. The control method according to claim 7, wherein
advancement of the valve-closing timing of the intake valve is restricted, and the throttle opening is made smaller than the throttle opening corresponding to the target engine torque, when the engine is started through ignition starting in which a fuel is injected into and ignited in a cylinder of the engine from a beginning of rotation of the engine.

9. The control method according to claim 7, wherein
advancement of the valve-closing timing of the intake valve is restricted, and the throttle opening is made smaller than the throttle opening corresponding to the target engine torque, when a rotational speed of the motor is equal to or lower than a predetermined motor speed determination value.

10. The control method according to claim 6, further comprising:
making a throttle opening of the engine before full engagement of the clutch smaller than a throttle opening of the engine after full engagement of the clutch, during the engine starting control.
